(19) United States
(12) Patent Application Publication
(10) Pub. No.: US 2017/0126048 A1
(43) Pub. Date: May 4, 2017

(54) PORTABLE MULTI-FUNCTION WIRELESS CHARGING ACCESSORY

(71) Applicant: COREMATE TECHNICAL CO., LTD., TAOYUAN COUNTY (TW)

(72) Inventor: Robert Wang, TAOYUAN COUNTY (TW)

(21) Appl. No.: 14/931,660

(22) Filed: Nov. 3, 2015

(51) Int. Cl. H02J 7/02; H02J 7/00

(52) U.S. Cl. CPC H02J 7/025; H02J 7/0042

(57) ABSTRACT

A portable multi-function wireless charging accessory includes a main body connected with a cable connector. The main body has a receiving trough thereon. One end of the cable connector is pivotally connected to the receiving trough of the main body, and the other end of the cable connector is connected with a connecting head. The cable connector can be folded and received in the receiving trough, such that the portable multi-function wireless charging accessory can be taken along more conveniently. By curving the cable connector, the connecting head can be connected with a portable electronic apparatus placed at a different height. The present invention is practicable and convenient for use and easy to take along.

### BACKGROUND OF THE INVENTION

1. Field of the Invention

The present invention relates to a wireless charging accessory, and more particularly to a portable multi-function wireless charging accessory.

2. Description of the Prior Art

These days, portable electronic apparatuses are widely used, such as smart phones, tablet personal computers, smart watches, and the like. People always carry the portable electronic apparatuses to go out. When people are out, the portable electronic apparatuses may have the problem that the power is not enough. People often carry a mobile power pack and a charging cable for a smart phone. When the power of the smart phone is not enough, the charging cable is used to connect the mobile power pack with the smart phone for supplying power to the smart phone. When people come to some sites, such as coffeehouses, restaurants or the like, they can use the socket there. However, the charging cable connecting the socket with the smart phone may cause that somebody stumbles or the smart phone is pulled to fall down. In order to solve this problem, many coffeehouses or restaurants provide a wireless charging pad on each table for wireless charging. If the user's smart phone doesn't have a build-in wireless charging module, it is necessary to fit a casing having a wireless charging module on the smart phone. The casing is provided with a connecting head corresponding to the charging hole of the smart phone. When the casing is fitted on the smart phone by the user, the connecting head of the casing is inserted into the charging hole of the smart phone. After that, the smart phone is placed on the wireless charging pad for the smart phone to get power through the casing. The casing can function as a protection casing for the user to take along conveniently. There is no need for the user to connect the charging cable for charging.

Although the aforesaid casing having a wireless charging module is convenient for charging, the casing is applied to only one type of a smart phone. It cannot be used for different types of smart phones or other portable electronic apparatuses for charging. When the casing is fitted on the smart phone, the charging hole of the smart phone is occupied by the connecting head of the casing. When the user has a need to use the charging hole, it is necessary to detach the casing from the smart phone for using the charging hole of the smart phone. Thus, the casing having a wireless charging module is not practicable and inconvenient for use. Accordingly, the inventor of the present invention has devoted himself based on his many years of practical experiences to solve these problems.

### SUMMARY OF THE INVENTION

The primary object of the present invention is to provide a portable multi-function wireless charging accessory which can be connected with different kinds and types of portable electronic apparatuses for wireless charging. The present invention is practicable and convenient for use and easy to take along.

In order to achieve the object, the portable multi-function wireless charging accessory of the present invention comprises a main body and a cable connector. The main body is in a disk-like shape. The main body has a receiving trough thereon. The main body comprises an induction coil therein for charging. The cable connector comprises a connecting head at a front end thereof. A rear end of the cable connector is pivotally connected to the receiving trough of the main body. The connecting head is electrically connected with the induction coil.

The cable connector the portable multi-function wireless charging accessory of the present invention can be folded and received in the receiving trough, such that the portable multi-function wireless charging accessory can be taken along more conveniently. By curving the cable connector, the connecting head can be connected with a portable electronic apparatus placed at a different height. The connecting head can be connected with different kinds and types of portable electronic apparatuses for wireless charging. The present invention is practicable and convenient for use and easy to take along.

### BRIEF DESCRIPTION OF THE DRAWINGS

FIG. 1 is a perspective view according to a preferred embodiment of the present invention;

FIG. 2 is a perspective view of the preferred embodiment of the present invention, showing that the cable connector is taken out from the receiving trough;

FIG. 3 is a schematic view of the preferred embodiment of the present invention when in use;

FIG. 4 is a schematic view of the preferred embodiment of the present invention, showing that the cable connector is bent for use;

FIG. 5 is a schematic view of the preferred embodiment of the present invention as a key ring;

FIG. 6 is a schematic view of the preferred embodiment of the present invention in a donut shape; and

FIG. 7 is a schematic view of the preferred embodiment of the present invention in a hamburger shape.

### DETAILED DESCRIPTION OF THE PREFERRED EMBODIMENTS

Embodiments of the present invention will now be described, by way of example only, with reference to the accompanying drawings.

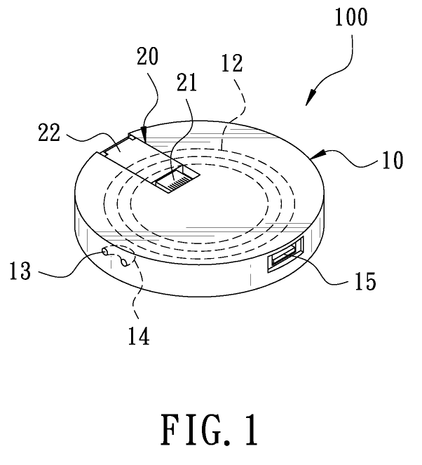

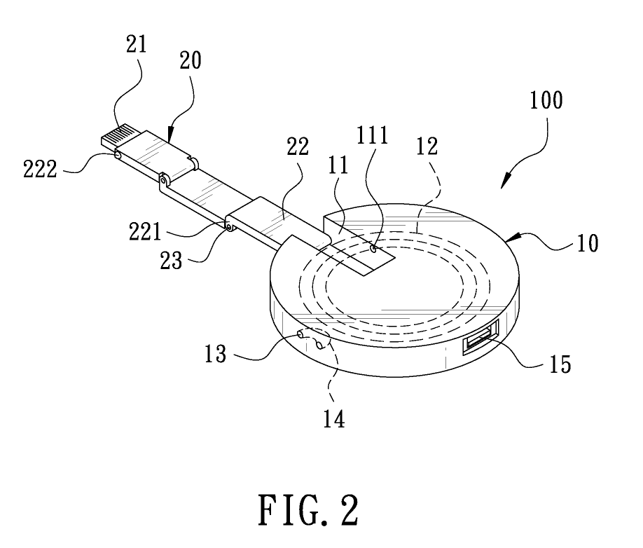

FIG. 1 is a perspective view according to a preferred embodiment of the present invention. FIG. 2 is a perspective view of the preferred embodiment of the present invention, showing the cable connector is taken out from the receiving trough. The present invention discloses a portable multi-function wireless charging accessory 100. The portable multi-function wireless charging accessory 100 comprises a main body 10 and a cable connector 20.

The main body 10 has a disk-like shape. The main body 10 has a receiving trough 11 thereon. The main body 10 comprises an induction coil 12 therein for charging. In the preferred embodiment of the present invention, two side walls of the receiving trough 11 are formed with a pair of recesses 111. An outer circumference of the main body 10 is formed with two apertures 13. The interior of the main body 10 has a space 14 for the two apertures 13 to communicate with each other. The two apertures 13 are adapted for insertion of a rope. The outer circumference of the main body 10 is further formed with at least one USB insertion hole 15. In addition, the main body 10 further comprises a memory card therein to function as a USB flash drive.

The cable connector 20 comprises a connecting head 21 at a front end thereof. A rear end of the cable connector 20 is pivotally connected to the receiving trough 11 of the main body 10 and electrically connected with the induction coil 12. In the preferred embodiment of the present invention, the cable connector 20 is composed of a plurality of boards 22. A connecting portion 221 is provided at the junction of every two of the boards 22. The connecting portion 221 is a pair of connecting arms extending out from the board 22 or a connecting block corresponding to the connecting arms. The connecting block is disposed between the connecting arms of the adjacent boards 22. Through a pivot 23, the connecting arms and the connecting block are pivotally connected together, such that the boards 22 are connected with each other and can be folded and received in the receiving trough 11. Besides, the distal board 22 is provided with the connecting head 21. Left and right sides of the distal board 22 are provided with a pair of protrusions 222 corresponding to the recesses 111. The protrusions 222 are engaged with the recesses 111.

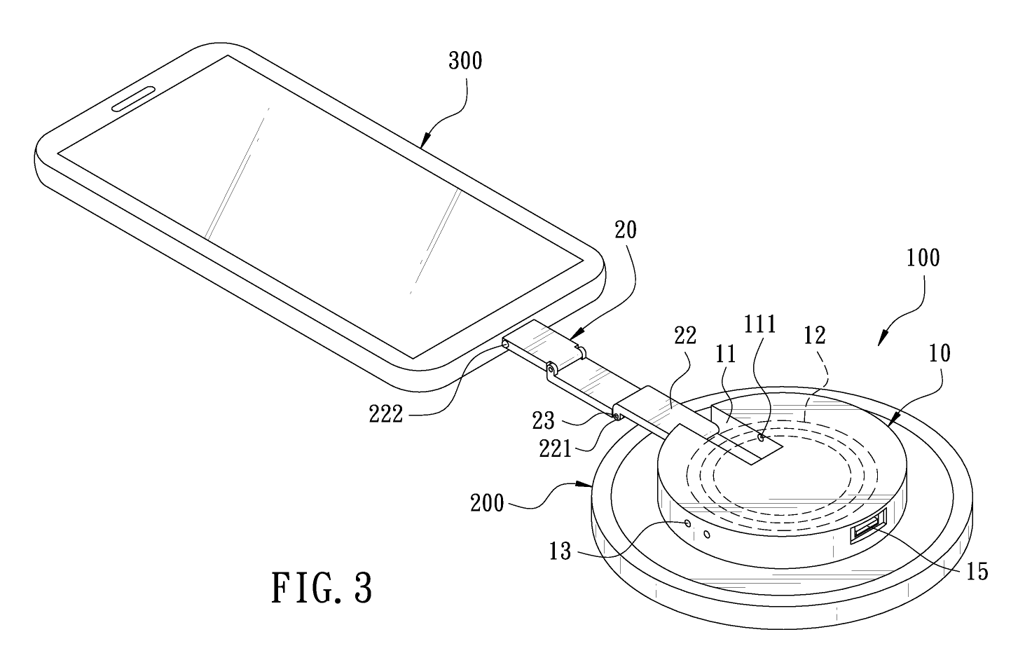

FIG. 3 is a schematic view of the preferred embodiment of the present invention when in use. Referring to FIG. 1 and FIG. 2, when the user wants to use a wireless charging pad 200 to charge a portable electronic apparatus, such as a smart phone 300, the cable connector 20 is taken out from the receiving trough 11, the connecting head 21 is connected with a charging hole of the smart phone 300, and the main body 10 is placed on the wireless charging pad 200. As shown in FIG. 3, the present invention is connected with the smart phone 300 and placed on the wireless charging pad 200 for wireless charging. At this time, the induction coil 12 is adapted to receive the electric power of the wireless charging pad 200. The electric power is transmitted to the smart phone 300 through the connecting head 21 of the cable connector 20, enabling the smart phone 300 to get the electric power. After charging, the cable connector 20 can be received in the receiving trough 11. The boards 22 are pivotally connected by the pivot 23, such that the boards 22 can be folded and received in the receiving trough 11 by the protrusions 222 to engage with the recesses 111. When the cable connector 20 is received in the receiving trough 11, it can be received well and won't disengage from the receiving trough 11 easily. As shown in FIG. 1, the cable connector 20 is received in the receiving trough 11. Through the pivot 23 pivotally disposed between the boards 22 of the cable connector 20, the boards 22 can be pivoted on the pivot 23, so that the cable connector 20 can be folded and received in the receiving trough 11, enhancing the convenience of the portable wireless charging accessory. When the user wants to charge a portable electronic apparatus, the cable connector 20 is taken out from the receiving trough 11. The connecting head 21 is connected with the portable electronic apparatus for charging. The connecting head 21 can be connected with different kinds and types of portable electronic apparatuses for wireless charging. The present invention is practicable and convenient for use and easy to take along.

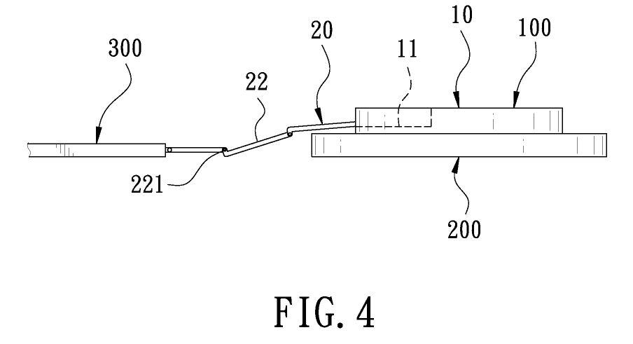

FIG. 4 is a schematic view of the preferred embodiment of the present invention, showing that the cable connector is bent for use. In conjunction with FIG. 1 through FIG. 3, because the cable connector 20 can be folded and received in the receiving trough 11, in case there is a height difference between the cable connector 20 and the smart phone 300, the cable connector 20 can be curved upward or downward for the user to connect the connecting head 21 of the cable connector 20 with the smart phone 300. As shown in FIG. 4, the cable connector 20 is curved downward and connected with the smart phone 300. This prevents the connecting head 21 from being damaged due to an improper connection and enhances the convenience of the wireless charging accessary.

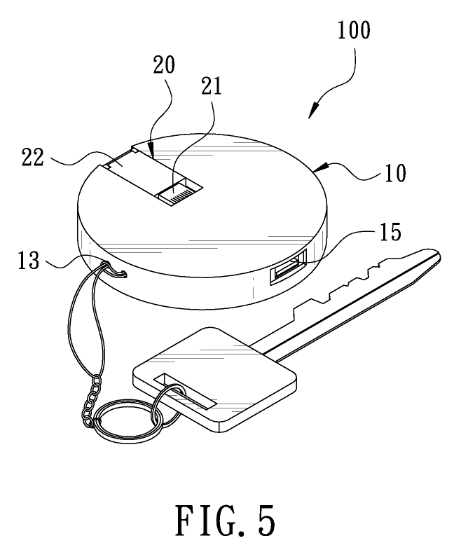

FIG. 5 is a schematic view of the preferred embodiment of the present invention functioning as a key ring. The two apertures 13 on the outer circumference of the main body 10 are adapted for insertion of a rope, such that the present invention functions as a key ring for the user to take along conveniently.

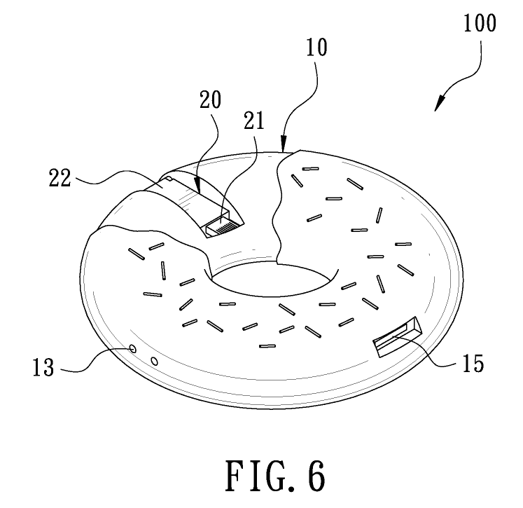

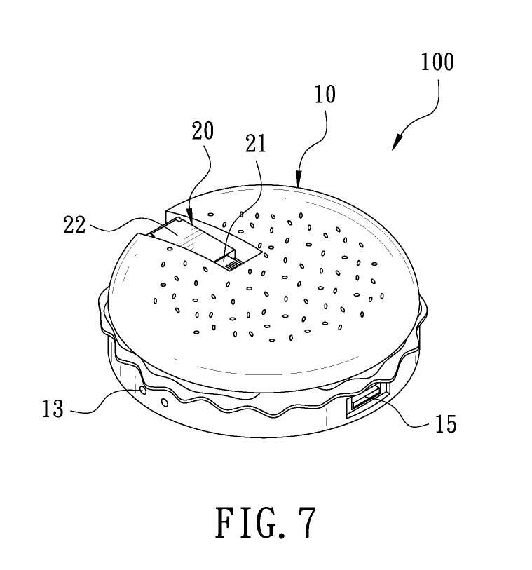

FIG. 6 is a schematic view of the preferred embodiment of the present invention in a donut shape. FIG. 7 is a schematic view of the preferred embodiment of the present invention in a hamburger shape. The main body 10 can be designed in different shapes, such as a donut shape as shown in FIG. 6 or a hamburger shape as shown in FIG. 7. It can be designed in a cake shape or a Macaron shape, so that the appearance of the present invention is more pleasing.

It is noted that the USB insertion hole 15 of the outer circumference of the main body 10 is adapted for insertion of a USB. In addition, the interior of the main body 10 is provided with a memory card, so that the prevention invention provides multiple functions.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A portable multi-function wireless charging accessory, comprising:
a main body having a disk-like shape, the main body having a receiving trough thereon, the main body comprising an induction coil therein for charging; and
a cable connector comprising a connecting head at a front end thereof, a rear end of the cable connector being pivotally connected to the receiving trough of the main body, the connecting head being electrically connected with the induction coil;
wherein, when the cable connector is in a folded state, the cable connector can be folded and received in the receiving trough, when the user wants to charge a portable electronic apparatus, the cable connector can be taken out from the receiving trough, enabling the connecting head to be connected with the portable electronic apparatus for charging.

2. The portable multi-function wireless charging accessory as claimed in claim 1, wherein the cable connector is composed of a plurality of boards, a connecting portion is provided at the junction of every two of the boards, the connecting portion is a pair of connecting arms extending out from one of the boards or a connecting block corresponding to the connecting arms, the connecting block is disposed between the connecting arms of the adjacent board, and the connecting arms and the connecting block are pivotally connected by a pivot, enabling the boards to be connected with each other and to be folded and received in the receiving trough.

3. The portable multi-function wireless charging accessory as claimed in claim 1, wherein two side walls of the receiving trough are formed with a pair of recesses, the distal board is provided with the connecting head, left and right sides of the distal board are provided with a pair of protrusions corresponding to the recesses, and the protrusions are engaged with the recesses.

4. The portable multi-function wireless charging accessory as claimed in claim 1, wherein an outer circumference of the main body is formed with two apertures, an interior of the main body has a space for the two apertures to communicate with each other, and the two apertures are adapted for insertion of a rope.

5. The portable multi-function wireless charging accessory as claimed in claim 1, wherein an outer circumference of the main body is formed with at least one USB insertion hole.

6. The portable multi-function wireless charging accessory as claimed in claim 1, wherein the main body further comprises a memory card therein to function as a USB flash drive.
